(19) United States
(12) Patent Application Publication
(10) Pub. No.: US 2025/0309255 A1
(43) Pub. Date: Oct. 2, 2025

(54) NICKEL-CONTAINING HYDROXIDE COATED WITH COBALT AND METHOD FOR PRODUCING NICKEL-CONTAINING HYDROXIDE COATED WITH COBALT

(71) Applicant: TANAKA CHEMICAL CORPORATION, Fukui (JP)

(72) Inventor: Hiroaki ISHIDA, Fukui (JP)

(73) Assignee: TANAKA CHEMICAL CORPORATION, Fukui (JP)

(21) Appl. No.: 19/089,727

(22) Filed: Mar. 25, 2025

(30) Foreign Application Priority Data
Mar. 26, 2024 (JP) 2024-050492

(51) Int. Cl. H01M 4/525; C01G 53/84; H01M 4/02; H01M 4/36

(52) U.S. Cl. CPC H01M 4/525; C01G 53/84; H01M 4/366; C01P 2004/32; C01P 2004/61; C01P 2004/84; C01P 2006/11; C01P 2006/12; C01P 2006/40; H01M 2004/021; H01M 2004/028

(57) ABSTRACT

Provided is a nickel-containing hydroxide coated with cobalt, having a coating layer containing cobalt oxyhydroxide formed on a nickel-containing hydroxide, in which an average circularity of particles having particle diameters equal to or more than a particle diameter at a cumulative volume percentage of 50% (D50) within a range of 0.900 or more and 0.990 or less.

### CROSS REFERENCE TO RELATED APPLICATIONS

The present application claims the benefit of foreign priority to Japanese Patent Application No. 2024-050492, filed on Mar. 26, 2024, which is incorporated herein by reference in its entirety.

### BACKGROUND

### Technical Field

The present disclosure relates to a nickel-containing hydroxide coated with cobalt in which uneven coating of the nickel-containing hydroxide coated with cobalt serving as a positive electrode active material is reduced during production of a positive electrode for a secondary battery and an increase in battery resistance is thereby prevented, and volume resistivity is reduced, by controlling an average circularity of particles having particle diameters equal to or more than a particle diameter at a cumulative volume percentage of 50% (D50) within a predetermined range.

### Description of the Related Art

With high functionalization of devices and the like, improvement in battery characteristics of secondary batteries such as nickel hydrogen secondary batteries has been increasingly required, in recent years. Thus, a nickel-containing hydroxide having a higher content of cobalt has been developed to improve battery characteristics in a nickel-containing hydroxide coated with cobalt for a positive electrode active material for a secondary battery.

Moreover, to increase the content of cobalt, a coating layer of a cobalt compound is formed on nickel hydroxide particles. As the nickel hydroxide particles on which a coating layer of a cobalt compound is formed, for example, proposed is coated nickel hydroxide powder for an alkaline secondary battery positive electrode active material in which the particle surface of the nickel hydroxide powder is coated with a cobalt compound containing, as a main component, cobalt oxyhydroxide or a mixture of cobalt oxyhydroxide and cobalt hydroxide to ensure the uniformity and adhesiveness of the coating layer, wherein the valence of the cobalt in the coating is 2.5 or more, and the amount of peeling of the coating when 20 g of the coated nickel hydroxide powder is shaken in a sealed container for 1 hour is 20% by mass or less based on the total amount of coating (Japanese Patent Application Laid-Open No. 2014-103127).

When uneven coating of a nickel-containing hydroxide coated with cobalt serving as a positive electrode active material occurs during production of a positive electrode, battery resistance may be increased. Thus, to improve battery characteristics, reduction in uneven coating of the nickel-containing hydroxide coated with cobalt may be required. In addition, to improve battery characteristics, further reduction in volume resistivity of the nickel-containing hydroxide coated with cobalt may be required.

However, the coated nickel hydroxide powder for an alkaline secondary battery positive electrode active material of Japanese Patent Application Laid-Open No. 2014-103127 has room for improvement in terms of reducing uneven coating of the coated nickel hydroxide powder for an alkaline secondary battery positive electrode active material during production of a positive electrode and further reducing volume resistivity.

The present disclosure is related to providing a nickel-containing hydroxide coated with cobalt capable of reducing uneven coating during production of a positive electrode and thereby preventing an increase in battery resistance, and having reduced volume resistivity by controlling an average circularity of particles having particle diameters equal to or more than a particle diameter at a cumulative volume percentage of 50% (D50) within a predetermined range, and a method for producing the nickel-containing hydroxide coated with cobalt.

### SUMMARY

The gist of the constitution of the present disclosure is as follows.
[1] A nickel-containing hydroxide coated with cobalt, having a coating layer containing cobalt oxyhydroxide formed on a nickel-containing hydroxide, wherein
   an average circularity of particles having particle diameters equal to or more than a particle diameter at a cumulative volume percentage of 50% (D50) within a range of 0.900 or more and 0.990 or less.
[2] The nickel-containing hydroxide coated with cobalt according to [1], wherein the particle diameter at a cumulative volume percentage of 50% (D50) is 8.5 μm or more and 14.5 μm or less.
[3] The nickel-containing hydroxide coated with cobalt according to [1] or [2], wherein a volume resistivity is 4.0 Ω·cm or less.
[4] The nickel-containing hydroxide coated with cobalt according to any one of [1] to [3], wherein the nickel-containing hydroxide contains nickel (Ni) and one or more additive metal elements M selected from the group consisting of cobalt (Co) and zinc (Zn).
[5] The nickel-containing hydroxide coated with cobalt according to [4], wherein a molar ratio of nickel (Ni):additive metal element M is 100−m:m (provided that 0.00≤m≤20.0).
[6] The nickel-containing hydroxide coated with cobalt according to any one of [1] to [5], wherein the nickel-containing hydroxide coated with cobalt contains nickel (Ni) and cobalt (Co), or nickel (Ni), cobalt (Co), and zinc (Zn), and a molar ratio of nickel (Ni):cobalt (Co):zinc (Zn) is 100-x-y:x:y (provided that 0.00<x≤10.0 and 0.00≤y≤10.0).
[7] The nickel-containing hydroxide coated with cobalt according to any one of [1] to [6], wherein a BET specific surface area is 10.0 m²/g or more and 25.0 m²/g or less.
[8] The nickel-containing hydroxide coated with cobalt according to any one of [1] to [7], wherein a tap density is 1.5 g/cm³ or more and 2.4 g/cm³ or less.
[9] The nickel-containing hydroxide coated with cobalt according to any one of [1] to [8], wherein the nickel-containing hydroxide coated with cobalt is for a positive electrode active material of a nickel hydrogen secondary battery.
[10] A positive electrode having the nickel-containing hydroxide coated with cobalt according to any one of [1] to [9] and a metal current collector.
[11] A nickel hydrogen secondary battery containing the positive electrode according to [10].
[12] A method for producing a nickel-containing hydroxide coated with cobalt, having:
   a step of preparing a nickel-containing hydroxide, the step including adding a metal salt solution containing nickel, an alkaline solution, and a complexing agent into a reaction vessel to prepare a nickel-containing hydroxide by a crystallization reaction,
   a step of preparing a nickel-containing hydroxide on which a coating layer containing cobalt is formed, the step including adding the nickel-containing hydroxide, a cobalt salt solution, an alkaline solution, and a complexing agent into a reaction vessel to form a coating layer containing divalent cobalt on the surface of nickel-containing hydroxide particles by a crystallization reaction, and
   an oxidation step of adding an alkaline solution to the nickel-containing hydroxide on which the coating layer containing cobalt is formed under heating conditions to chemically oxidize the divalent cobalt in the coating layer, wherein
   a temperature (° C.) of an alkaline solution-containing material obtained by adding the alkaline solution to the nickel-containing hydroxide on which a coating layer containing cobalt is formed at 0 seconds from the start of addition of the alkaline solution, and temperatures (° C.) of the alkaline solution-containing material until 280 seconds after the start of addition of the alkaline solution are measured every 20 seconds from the start of addition of the alkaline solution, and a sum of calculated values A (° C.×min) every 20 seconds represented by [the temperature of the alkaline solution-containing material (° C.)×20 (seconds)]/60 from 0 seconds until 300 seconds from the start of addition of the alkaline solution is 350 or more and 420 or less.
[13] The method for producing a nickel-containing hydroxide coated with cobalt according to [12], wherein the oxidation step is carried out in a reaction vessel, and a gas phase in the reaction vessel is replaced with heated gas.
[14] The method for producing a nickel-containing hydroxide coated with cobalt according to or [13], wherein the oxidation step is carried out in a reaction vessel, and the alkaline solution-containing material is dried in the reaction vessel.

In the nickel-containing hydroxide coated with cobalt, the nickel-containing hydroxide has a coating layer, and the coating layer contains a cobalt compound.

In the above aspect [1], the “average circularity” means an average value obtained by measuring the circularity of each of the nickel-containing hydroxide particles coated with cobalt with a static automatic image analyzer and averaging the measured circularities of the nickel-containing hydroxide powder coated with cobalt.

According to the nickel-containing hydroxide coated with cobalt of an embodiment of the present disclosure, when the average circularity of particles having particle diameters equal to or more than a particle diameter at a cumulative volume percentage of 50% (D50) within a range of 0.900 or more and 0.990 or less, the nickel-containing hydroxide coated with cobalt capable of reducing uneven coating of the nickel-containing hydroxide coated with cobalt during production of the positive electrode and thereby preventing an increase in battery resistance, and having reduced volume resistivity can be obtained.

According to the nickel-containing hydroxide coated with cobalt of an embodiment of the present disclosure, when the volume resistivity is 4.0 Ω·cm or less, electrical conductivity is more improved, and superior battery characteristics can be obtained.

According to the nickel-containing hydroxide coated with cobalt of an embodiment of the present disclosure, when the nickel-containing hydroxide coated with cobalt contains nickel (Ni) and cobalt (Co), or nickel (Ni), cobalt (Co), and zinc (Zn), and the molar ratio of nickel (Ni):cobalt (Co):zinc (Zn) is 100-x-y:x:y (provided that 0.00<x≤10.0 and 0.00≤y≤10.0), a high utilization factor and excellent charge and discharge characteristics can be obtained, and superior electrical conductivity can be obtained.

According to the method for producing a nickel-containing hydroxide coated with cobalt of an embodiment of the present disclosure, when the temperature (° C.) of an alkaline solution-containing material obtained by adding an alkaline solution to a nickel-containing hydroxide on which a coating layer containing cobalt is formed at 0 seconds from the start of addition of the alkaline solution, and temperatures (° C.) of the alkaline solution-containing material until 280 seconds after the start of addition of the alkaline solution are measured every 20 seconds from the start of addition of the alkaline solution, and the sum of calculated values A (° C.×min) every 20 seconds represented by [the temperature of the alkaline solution-containing material (° C.)×20 (seconds)]/60 from 0 seconds until 300 seconds from the start of addition of the alkaline solution is 350 or more and 420 or less, the nickel-containing hydroxide coated with cobalt capable of reducing uneven coating of the nickel-containing hydroxide coated with cobalt during production of the positive electrode and thereby preventing an increase in battery resistance, and having reduced volume resistivity can be obtained.

### DETAILED DESCRIPTION

Hereinafter, the nickel-containing hydroxide coated with cobalt of the present disclosure will be described in detail. In the nickel-containing hydroxide coated with cobalt of the present disclosure, a coating layer of a cobalt compound is formed on the surface of nickel-containing hydroxide particles. That is, the nickel-containing hydroxide particles are core particles, and the core particles are coated with a layer of a cobalt compound, for example, mainly a layer of a cobalt compound in which the valence of cobalt is trivalent. Examples of the cobalt compound in which the valence of cobalt is trivalent include cobalt oxyhydroxide. As described above, the nickel-containing hydroxide coated with cobalt of the present disclosure is particles having a coating layer containing cobalt oxyhydroxide formed on nickel-containing hydroxide particles.

Examples of the shape of the nickel-containing hydroxide particles coated with cobalt include, but are not particularly limited to, a substantially spherical shape. In an aspect, the nickel-containing hydroxide particles are, for example, secondary particles formed by aggregation of a plurality of primary particles. The coating layer containing cobalt oxyhydroxide of the nickel-containing hydroxide particles coated with cobalt may coat the entire surface of the nickel-containing hydroxide particles, or may coat a partial region on the surface of the nickel-containing hydroxide particles.

In the nickel-containing hydroxide coated with cobalt of the present disclosure, the average circularity of particles having particle diameters equal to or more than a particle diameter at a cumulative volume percentage of 50% (D50) (hereinafter, simply referred to as “D50”) within a range of 0.900 or more and 0.990 or less. Within the above range, uneven coating of the nickel-containing hydroxide coated with cobalt during production of a positive electrode is reduced, so that an increase in battery resistance can be prevented, and the volume resistivity of the nickel-containing hydroxide coated with cobalt can be reduced.

The average circularity of the nickel-containing hydroxide powder coated with cobalt of D50 or more is an average value obtained by measuring the circularity of each of 10,000 nickel-containing hydroxide particles coated with cobalt with a static automatic image analyzer (e.g., Morphologi 4, Malvern Panalytical Ltd) and averaging the measured circularities of the nickel-containing hydroxide powder coated with cobalt of D50 or more. Specifically, the average circularity can be calculated by the following method. The nickel-containing hydroxide powder coated with cobalt is introduced into a feed unit of the analyzer, blown to a prepared slide, and fixed. 10,000 of the fixed nickel-containing hydroxide particles coated with cobalt are observed with an optical microscope to obtain an image. The obtained image is analyzed to calculate the average circularity of the nickel-containing hydroxide powder coated with cobalt of D50 or more. Note that D50 means the particle diameter measured with a particle size distribution analyzer using a laser diffraction scattering method.

As described below, the average circularity of the nickel-containing hydroxide coated with cobalt of D50 or more can be adjusted by controlling the heating conditions of an alkaline solution-containing material obtained by adding an alkaline solution to the nickel-containing hydroxide on which a coating layer containing cobalt is formed, in the oxidation step of the coating layer in the production of the nickel-containing hydroxide coated with cobalt.

The average circularity of the nickel-containing hydroxide coated with cobalt of D50 or more is not particularly limited, as long as the average circularity is in a range of 0.900 or more and 0.990 or less, and the lower limit value is preferably 0.905, and particularly preferably 0.910, from the viewpoint that uneven coating of the nickel-containing hydroxide coated with cobalt during production of a positive electrode can be further reduced and an increase in battery resistance can be further prevented, and the volume resistivity of the nickel-containing hydroxide coated with cobalt can be further reduced. Meanwhile, the upper limit value of the average circularity of the nickel-containing hydroxide coated with cobalt of D50 or more is preferably 0.970, and particularly preferably 0.950, from the viewpoint that the volume resistivity of the nickel-containing hydroxide coated with cobalt can be reduced. Note that the lower limit value and the upper limit value described above can be arbitrarily combined. The average circularity of the nickel-containing hydroxide coated with cobalt of D50 or more is, for example, preferably 0.905 or more and 0.970 or less, and particularly preferably 0.910 or more and 0.950 or less.

The volume resistivity of the nickel-containing hydroxide coated with cobalt of the present disclosure is not particularly limited, and is preferably 4.0 Ω·cm or less, more preferably 3.9 Ω·cm or less, and particularly preferably 3.5 Ω·cm or less, from the viewpoint that the electrical conductivity of the nickel-containing hydroxide coated with cobalt can be more improved and superior battery characteristics can be obtained. Meanwhile, the lower limit value of the volume resistivity of the nickel-containing hydroxide coated with cobalt is preferably as low as possible. Examples of the lower limit value of the volume resistivity of the nickel-containing hydroxide coated with cobalt include 0.4 Ω·cm. Note that the upper limit value and the lower limit value described above can be arbitrarily combined. The volume resistivity of the nickel-containing hydroxide coated with cobalt is, for example, preferably 0.4 Ω·cm or more and 4.0 Ω·cm or less, more preferably 0.4 Ω·cm or more and 3.9 Ω·cm or less, and particularly preferably 0.4 Ω·cm or more and 3.5 Ω·cm or less.

D50 of the nickel-containing hydroxide coated with cobalt of the present disclosure is not particularly limited, and the lower limit value is preferably 8.5 μm or more, more preferably 9.0 μm or more, and particularly preferably 9.5 μm or more, from the viewpoint of maintaining high circularity while reducing uneven coating of the nickel-containing hydroxide coated with cobalt during production of the positive electrode. Meanwhile, the upper limit value of D50 of the nickel-containing hydroxide coated with cobalt is preferably 14.5 μm or less, more preferably 14.0 μm or less, and particularly preferably 13.5 μm or less, from the viewpoint of reducing uneven coating of the nickel-containing hydroxide coated with cobalt during production of the positive electrode. Note that the lower limit value and the upper limit value described above can be arbitrarily combined. D50 of the nickel-containing hydroxide coated with cobalt is, for example, preferably 8.5 μm or more and 14.5 μm or less, more preferably 9.0 μm or more and 14.0 μm or less, and particularly preferably 9.5 μm or more and 13.5 μm or less.

The particle diameter (D90) at a cumulative volume percentage of 90% by volume (hereinafter, simply referred to as “D90”) of the nickel-containing hydroxide coated with cobalt of the present disclosure is not particularly limited, and the lower limit value is preferably 14.0 μm or more, and particularly preferably 14.5 μm or more, from the viewpoint of improving the packing density of the nickel-containing hydroxide coated with cobalt. Meanwhile, the upper limit value of D90 of the nickel-containing hydroxide coated with cobalt is preferably 20.0 μm or less, and particularly preferably 19.5 μm or less, from the viewpoint of reducing uneven coating. Note that the lower limit value and the upper limit value described above can be arbitrarily combined. D90 of the nickel-containing hydroxide coated with cobalt is, for example, preferably 14.0 μm or more and 20.0 μm or less, and particularly preferably 14.5 μm or more and 19.5 μm or less. D90 means the particle diameter measured with a particle size distribution analyzer using a laser diffraction scattering method.

The particle diameter (D10) at a cumulative volume percentage of 10% by volume (hereinafter simply referred to as “D10”) of the nickel-containing hydroxide coated with cobalt of the present disclosure is not particularly limited, and the lower limit value is preferably 5.5 μm or more, and particularly preferably 6.0 μm or more, from the viewpoint of improving the packing density of the nickel-containing hydroxide coated with cobalt. Meanwhile, the upper limit value of D10 of the nickel-containing hydroxide coated with cobalt is preferably 10.0 μm or less, and particularly preferably 9.5 μm or less, from the viewpoint of ensuring the contact surface with an electrolytic solution. Note that the lower limit value and the upper limit value described above can be arbitrarily combined. D10 of the nickel-containing hydroxide coated with cobalt is, for example, preferably 5.5 μm or more and 10.0 μm or less, and particularly preferably 6.0 μm or more and 9.5 μm or less. D10 means the particle diameter measured with a particle size distribution analyzer using a laser diffraction scattering method.

The particle size distribution width ((D90-D10)/D50) of the nickel-containing hydroxide coated with cobalt of the present disclosure is not particularly limited, and is preferably 0.5 or more and 1.2 or less, and particularly preferably 0.6 or more and 1.1 or less, from the viewpoint that uneven coating of the nickel-containing hydroxide coated with cobalt during production of the positive electrode can be further reduced.

The composition of the nickel-containing hydroxide as core particles is not particularly limited, as long as the hydroxide contains nickel (Ni), and it is preferable that the hydroxide contain nickel (Ni) and one or more additive metal elements M selected from the group consisting of cobalt (Co) and zinc (Zn), from the viewpoint of obtaining a high utilization factor, excellent charge and discharge characteristics, and excellent electrical conductivity. In addition, it is preferable that cobalt and zinc be contained in states of a cobalt solid solution and a zinc solid solution. That is, the nickel-containing hydroxide as core particles is preferably a nickel hydroxide in which cobalt and/or zinc form(s) a solid solution, that is, a nickel-containing hydroxide.

The molar ratio of nickel:additive metal element M is not particularly limited, and the molar ratio of nickel:additive metal element M is preferably 100-m:m (provided that 0.00≤m≤20.0), more preferably 2.00≤m≤18.0, and particularly preferably 4.00≤m≤15.0, from the viewpoint of obtaining a high utilization factor, excellent charge and discharge characteristics, and excellent electrical conductivity.

It is preferable that the nickel-containing hydroxide coated with cobalt contain nickel and cobalt, or nickel, cobalt and zinc, from the viewpoint of further obtaining a high utilization factor, excellent charge and discharge characteristics, and excellent electrical conductivity. The molar ratio of nickel:cobalt:zinc is not particularly limited, and the molar ratio of nickel:cobalt:zinc is preferably 100-x-y:x:y (provided that 0.00<x≤10.0 and 0.00≤y≤10.0), more preferably 1.00≤x≤9.00 and 1.00≤y≤8.00, and particularly preferably 3.00≤x≤8.00 and 2.00≤y≤6.00, from the viewpoint that a high utilization factor and excellent charge and discharge characteristics can be obtained, and superior electrical conductivity can be obtained.

In the nickel-containing hydroxide coated with cobalt of the present disclosure, the content of cobalt oxyhydroxide in the cobalt compound of the coating layer containing cobalt oxyhydroxide is not particularly limited, and the lower limit value is preferably 70% by mass or more, and particularly preferably 80% by mass or more, from the viewpoint of more improving electrical conductivity. In addition, the upper limit value of the content of cobalt oxyhydroxide in the cobalt compound of the coating layer containing cobalt oxyhydroxide is preferably as high as possible, and a coating layer composed of cobalt oxyhydroxide (the content of cobalt oxyhydroxide is about 100% by mass) is particularly preferable. In the coating layer containing cobalt oxyhydroxide, cobalt oxide other than cobalt oxyhydroxide may be inevitably contained in the production process.

The cobalt oxyhydroxide contained in the coating layer has a diffraction peak in diffraction angles from 65° to 66° which are represented by 20 in a diffraction pattern obtained by X-ray diffraction measurement. The cobalt content contained in the coating layer is not particularly limited, and the cobalt content contained in the coating layer containing cobalt is preferably more than 0% by mass and 6% by mass or less, and particularly preferably 2% by mass or more and 5% by mass or less, from the viewpoint of obtaining a high utilization factor, excellent charge and discharge characteristics, and excellent electrical conductivity.

In the nickel-containing hydroxide coated with cobalt of the present disclosure, the content of nickel in the nickel-containing hydroxide is not particularly limited, and the lower limit value is preferably 85% by mole or more, more preferably 87% by mole or more, and particularly preferably 90% by mole or more. Meanwhile, the upper limit value is preferably 100% by mole or less, and particularly preferably 97% by mole or less. Note that the lower limit value and the upper limit value described above can be arbitrarily combined. The content of nickel in the nickel-containing hydroxide is, for example, preferably 85% by mole or more and 100% by mole or less, more preferably 87% by mole or more and 100% by mole or less, and particularly preferably 90% by mole or more and 97% by mole or less.

The BET specific surface area of the nickel-containing hydroxide coated with cobalt of the present disclosure is not particularly limited, and the lower limit value is preferably 10.0 m²/g or more, more preferably 10.5 m²/g or more, and particularly preferably 11.0 m²/g or more, from the viewpoint of further reducing uneven coating of the nickel-containing hydroxide coated with cobalt during production of the positive electrode while ensuring the improvement in density and the contact surface with an electrolytic solution. Meanwhile, the upper limit value of the BET specific surface area of the nickel-containing hydroxide particles coated with cobalt is preferably 25.0 m²/g or less, more preferably 24.5 m²/g or less, and particularly preferably 24.0 m²/g or less, from the viewpoint of obtaining particle strength while reducing uneven coating of the nickel-containing hydroxide coated with cobalt during production of the positive electrode. Note that the lower limit value and the upper limit value described above can be arbitrarily combined. The BET specific surface area of the nickel-containing hydroxide coated with cobalt is, for example, preferably 10.0 m²/g or more and 25.0 m²/g or less, more preferably 10.5 m²/g or more and 24.5 m²/g or less, and particularly preferably 11.0 m²/g or more and 24.0 m²/g or less.

The tap density of the nickel-containing hydroxide coated with cobalt of the present disclosure is not particularly limited, and the lower limit value is preferably 1.5 g/cm³ or more, more preferably 1.6 g/cm³ or more, and particularly preferably 1.7 g/cm³ or more, from the viewpoint of further reducing uneven coating of the nickel-containing hydroxide coated with cobalt during production of the positive electrode while improving packing density. Meanwhile, the upper limit value is preferably 2.4 g/cm³ or less, more preferably 2.3 g/cm³ or less, and particularly preferably 2.2 g/cm³ or less, from the viewpoint of obtaining the particle strength of the nickel-containing hydroxide coated with cobalt while reducing uneven coating of the nickel-containing hydroxide coated with cobalt during production of the positive electrode. Note that the lower limit value and the upper limit value described above can be arbitrarily combined. The tap density of the nickel-containing hydroxide coated with cobalt is, for example, preferably 1.5 g/cm³ or more and 2.4 g/cm³ or less, more preferably 1.6 g/cm³ or more and 2.3 g/cm³ or less, and particularly preferably 1.7 g/cm³ or more and 2.2 g/cm³ or less.

For example, the nickel-containing hydroxide coated with cobalt of the present disclosure can be used for a positive electrode active material of a nickel hydrogen secondary battery.

Thereafter, examples of the method for producing a nickel-containing hydroxide coated with cobalt of the present disclosure will be described.

The method for producing a nickel-containing hydroxide coated with cobalt of the present disclosure has, for example, a step of preparing a nickel-containing hydroxide, the step including adding a metal salt solution containing nickel, an alkaline solution, and a complexing agent into a reaction vessel to prepare a nickel-containing hydroxide by a crystallization reaction, a step of preparing a nickel-containing hydroxide on which a coating layer containing cobalt is formed, the step including adding the nickel-containing hydroxide, a cobalt salt solution, an alkaline solution, and a complexing agent into a reaction vessel to form a coating layer containing divalent cobalt on the surface of nickel-containing hydroxide particles by a crystallization reaction, and an oxidation step of adding an alkaline solution to the nickel-containing hydroxide on which the coating layer containing cobalt is formed under heating conditions to chemically oxidize the divalent cobalt in the coating layer.

### <Step of Preparing Nickel-Containing Hydroxide>

The step of preparing the nickel-containing hydroxide as core particles will be described below. Here, a method for preparing a nickel-containing hydroxide in which cobalt and zinc form a solid solution will be described as an example. First, a salt solution (e.g., sulfate salt solution) of nickel, cobalt, and zinc, a complexing agent, and an alkaline solution are reacted by a coprecipitation method to produce a nickel-containing hydroxide, thereby obtaining a slurry-like suspension containing the nickel-containing hydroxide. As the solvent of the suspension, for example, water is used.

The complexing agent is not particularly limited, as long as the complexing agent can form a complex with nickel, cobalt, and zinc ions in an aqueous solution, and examples of the complexing agent include ammonium ion donors (such as ammonium sulfate, ammonium chloride, ammonium carbonate, and ammonium fluoride), hydrazine, ethylenediaminetetraacetic acid, nitrilotriacetic acid, uracildiacetic acid, and glycine. The alkaline solution is not particularly limited, as long as the alkaline solution adjusts the pH value of the aqueous solution in coprecipitation, and examples of the alkaline solution include alkali metal hydroxides (e.g., sodium hydroxide and potassium hydroxide).

When the alkaline solution and the complexing agent are continuously supplied to a reaction vessel in addition to the above salt solution, nickel, cobalt, and zinc are subjected to a crystallization reaction to produce a nickel-containing hydroxide. In the crystallization reaction, the materials in the reaction vessel are arbitrarily stirred while controlling the temperature of the reaction vessel within a range of, for example, 10° C. to 80° C., preferably 20 to 70° C., and controlling the pH value in the reaction vessel within a range of, for example, pH 9 to pH 13, preferably pH 11 to 13 based on a liquid temperature of 40° C. Examples of the reaction vessel include a continuous reaction vessel that overflows the formed nickel-containing hydroxide for separation.

<Step of Preparing Nickel-Containing Hydroxide on which Coating Layer Containing Cobalt is Formed>

Thereafter, the suspension containing the nickel-containing hydroxide, a cobalt salt solution (e.g., an aqueous solution of cobalt sulfate), an alkaline solution (e.g., an aqueous sodium hydroxide solution), and a complexing agent (e.g., an aqueous ammonium sulfate solution) are added while stirring them with a stirrer to form a coating layer containing a divalent cobalt compound such as cobalt hydroxide as a main component on the surface of the nickel-containing hydroxide particles by neutralization crystallization, thereby preparing the nickel-containing hydroxide on which a coating layer containing cobalt is formed. The pH in the step of forming the above coating layer is preferably maintained in a range of 9 to 13 based on a liquid temperature of 40° C. The nickel-containing hydroxide on which a coating layer containing cobalt is formed can be obtained as a slurry-like suspension.

### <Solid-Liquid Separation and Drying Step Before Oxidation Step>

Before the oxidation step, a step of separating the suspension containing the nickel-containing hydroxide on which a coating layer containing cobalt is formed to a solid phase and a liquid phase, and drying the solid phase containing the nickel-containing hydroxide on which a coating layer containing cobalt is formed to obtain dry powder of the nickel-containing hydroxide on which a coating layer containing cobalt is formed may be further included, if necessary. In addition, the solid phase may be washed with water or the like before drying the solid phase, if necessary.

### <Oxidation Step>

Thereafter, the nickel-containing hydroxide on which a coating layer containing cobalt is formed is subjected to oxidation treatment. Examples of the method for oxidation treatment include chemical oxidation treatment in which an alkaline solution such as an aqueous sodium hydroxide solution is added to the nickel-containing hydroxide on which a coating layer containing cobalt is formed, and the mixture is mixed and heated. By the above oxidation treatment, the divalent cobalt in the nickel-containing hydroxide on which a coating layer containing cobalt is formed, can be oxidized to give cobalt oxyhydroxide as trivalent cobalt. By oxidizing the divalent cobalt in the coating layer to give cobalt oxyhydroxide, a nickel-containing hydroxide coated with cobalt in which a coating layer containing cobalt oxyhydroxide is formed can be obtained. In the oxidation treatment, addition of an alkaline solution, mixing, and heating may be simultaneously carried out.

In the method for producing a nickel-containing hydroxide coated with cobalt of the present disclosure, a temperature (° C.) of the alkaline solution-containing material obtained by adding an alkaline solution such as an aqueous sodium hydroxide solution to the nickel-containing hydroxide on which a coating layer containing cobalt is formed at 0 seconds from a start of addition of the alkaline solution, and temperatures (° C.) of the alkaline solution-containing material until 280 seconds after the start of addition of the alkaline solution are measured every 20 seconds from the start of addition of the alkaline solution, and the sum of calculated values A (° C.×min) every 20 seconds represented by [the temperature (° C.) in the alkaline solution-containing material×20 (seconds)]/60 from 0 seconds until 300 seconds from the start of addition of the alkaline solution is controlled to 350 or more and 420 or less, in the oxidation step.

That is, a calculated value A1 (° C.×min) of [the temperature (° C.) of the alkaline solution-containing material at 0 seconds from the start of addition of the alkaline solution (that is, immediately after addition of the alkaline solution)×20 (seconds)]/60, a calculated value A2 (° C.×min) of [the temperature (° C.) of the alkaline solution-containing material after 20 seconds from the start of addition of the alkaline solution×20 (seconds)]/60, a calculated value A3 (° C.×min) of [the temperature (° C.) of the alkaline solution-containing material after 40 seconds from the start of addition of the alkaline solution×20 (seconds)]/60, a calculated value A4 (° C.×min) of [the temperature (° C.) of the alkaline solution-containing material after 60 seconds from the start of addition of the alkaline solution×20 (seconds)]/60, . . . a calculated value A10 of [the temperature (° C.) of the alkaline solution-containing material after 180 seconds from the start of addition of the alkaline solution×20 (seconds)]/60, a calculated value A11 of [the temperature (° C.) of the alkaline solution-containing material after 200 seconds from the start of addition of the alkaline solution×20 (seconds)]/60, . . . and a calculated value A15 of [the temperature (° C.) of the alkaline solution-containing material after 280 seconds from the start of addition of the alkaline solution×20 (seconds)]/60 are calculated, and the sum of the calculated 15 calculated values A1 to A15 is controlled to 350 (° C.×min) or more and 420 (° C.×min) or less.

As described above, in the method for producing a nickel-containing hydroxide coated with cobalt of the present disclosure, the heating conditions upon addition of the alkaline solution is controlled in the oxidation step. Consequently, when the alkaline solution is added to the nickel-containing hydroxide on which a coating layer containing cobalt is formed, a rapid increase in the temperature of the alkaline solution-containing material is prevented and the degree of evaporation of the solvent such as water is adjusted, thereby making the progress of the oxidation reaction uniform.

In the method for producing a nickel-containing hydroxide coated with cobalt of the present disclosure, the sum of A1 to A15 is controlled to 350 or more and 420 or less, so that the progress of the oxidation reaction is made uniform and uneven coating of the nickel-containing hydroxide coated with cobalt during production of the positive electrode can be reduced. In addition, the progress of the oxidation reaction is made uniform, so that a nickel-containing hydroxide coated with cobalt having reduced volume resistivity can be obtained.

The oxidation step is carried out, for example, in a reaction vessel. The temperature in the reaction vessel in the oxidation step is preferably 80° C. or more and 150° C. or less, and more preferably 90° C. or more and 140° C. or less. The oxidation treatment time is preferably 0.5 hours or more and 10 hours or less, and more preferably 1 hour or more and 5 hours or less. The temperature of heated gas to be fed into the gas phase in the reaction vessel is preferably 100° C. or more and 150° C. or less, and more preferably 110° C. or more and 140° C. or less. By replacing the gas phase in the reaction vessel with heated gas, the degree of evaporation of the solvent such as water can be adjusted or promoted. The alkaline solution-containing material may be thermally influenced by the temperature in the reaction vessel or the temperature of the heated gas, but may not have the same temperature.

In the oxidation step, the alkaline solution-containing material may be dried in the reaction vessel to evaporate the solvent such as water until dry powder of the nickel-containing hydroxide coated with cobalt is obtained.

<Solid-Liquid Separation and Drying Step after Oxidation Step>

If necessary, after the oxidation step, the nickel-containing hydroxide coated with cobalt may be washed with water, and separated to a solid phase and a liquid phase after washing with water, and the solid phase containing the nickel-containing hydroxide coated with cobalt may be dried.

Thereafter, a positive electrode using the nickel-containing hydroxide coated with cobalt of the present disclosure, and a secondary battery using the positive electrode will be described. Here, a nickel hydrogen secondary battery will be described as an example of a secondary battery. The nickel hydrogen secondary battery includes a positive electrode using the nickel-containing hydroxide coated with cobalt of the present disclosure described above, a negative electrode, an alkaline electrolytic solution, and a separator.

The positive electrode includes a positive electrode current collector, and a positive electrode active material layer formed on the surface of the positive electrode current collector. The positive electrode active material layer has the nickel-containing hydroxide coated with cobalt, a binder, and if necessary, a conductive aid. The conductive aid is not particularly limited, as long as the conductive aid can be used for, for example, a nickel hydrogen secondary battery, and metallic cobalt, cobalt oxide, or the like may be used. Examples of the binder include, but are not particularly limited to, polymer resins such as polyvinylidene fluoride (PVdF), butadiene rubber (BR), polyvinyl alcohol (PVA), carboxymethylcellulose (CMC), and polytetrafluoroethylene (PTFE), and combinations of these polymer resins. Examples of the positive electrode current collector include, but are not particularly limited to, perforated metal, expand metal, wire mesh, foamed metal (e.g., foamed nickel), meshed metal fiber sintered bodies, metal plated resin plates, and metal foils.

As a method for producing the positive electrode, for example, first, the nickel-containing hydroxide coated with cobalt, a conductive aid, a binder, and water are mixed to prepare a positive electrode active material slurry. Then, the positive electrode active material slurry is filled into a positive electrode current collector by a known filling method, dried, and then rolled and fixed with a press or the like.

The negative electrode includes a negative electrode current collector, and a negative electrode active material layer that is formed on the surface of the negative electrode current collector and contains a negative electrode active material. The negative electrode active material is not particularly limited, as long as the active material is one usually used, and examples of the negative electrode active material include hydrogen storage alloy. As the negative electrode current collector, a conductive metal material such as nickel, aluminum, or stainless, which is the same material as the positive electrode current collector, can be used.

In the negative electrode active material layer, a conductive aid, a binder, or the like may be further added, if necessary. Examples of the conductive aid and the binder include similar materials to those used in the above positive electrode active material layer.

As a method for producing the negative electrode, for example, first, a negative electrode active material, and if necessary, a conductive aid and a binder are mixed with water to prepare a negative electrode active material slurry. Then, the above negative electrode active material slurry is filled into a negative electrode current collector by a known filling method, dried, and then rolled and fixed with a press or the like.

For the alkaline electrolytic solution, examples of the solvent include water, and examples of the solute to be dissolved in the solvent include potassium hydrate and sodium hydroxide. The solute may be used alone or in combination of two or more.

Examples of the separator include, but are not particularly limited to, polyolefin non-woven fabric such as polyethylene non-woven fabric and polypropylene non-woven fabric, polyamide non-woven fabric, and those obtained by subjecting these fabrics to hydrophilic treatment.

### EXAMPLES

Thereafter, examples of the present disclosure will be described, but the present disclosure is not limited to these examples without departing from the gist of the present disclosure.

### Example 1

### Preparation of Nickel-Containing Hydroxide

An aqueous solution in which zinc sulfate and nickel sulfate were dissolved in a molar ratio of 4.0:96.0, an aqueous ammonium sulfate solution (complexing agent), and an aqueous sodium hydroxide solution were added dropwise to a reaction vessel having a predetermined capacity, and while maintaining the temperature in the reaction vessel to 45° C. and the pH in the reaction vessel to 11.5 to 12.5 based on a liquid temperature of 40° C., the mixture was continuously stirred with a stirrer. The hydroxide produced was taken out by overflow from an overflow pipe of the reaction vessel. The above hydroxide taken out was subjected to each treatment of washing with water, dehydration, and drying to obtain a nickel-containing hydroxide.

### Formation of Coating Layer Containing Cobalt

The aqueous ammonium sulfate solution as the complexing agent was fed into a reaction vessel containing water so that the ammonia concentration in the reaction vessel was 9.0 to 13.0 g/L, the nickel-containing hydroxide obtained as described above was then fed to produce a slurry, and while maintaining the pH in the reaction vessel in a range of 9 to 13 based on a liquid temperature of 40° C. by adding an aqueous sodium hydroxide solution dropwise, the mixture was continuously stirred with a stirrer. While stirring the solution in the reaction vessel with a stirring blade, an aqueous cobalt sulfate solution having a concentration of 90 g/L was added dropwise. During this time, the pH of the solution in the reaction vessel was maintained in a range of 9 to 13 based on a liquid temperature of 40° C. by arbitrarily adding an aqueous sodium hydroxide solution dropwise, and a coating layer of cobalt hydroxide was formed on the surface of nickel-containing hydroxide particles, thereby obtaining a suspension of nickel-containing hydroxide coated with cobalt hydroxide. The suspension was prepared so that the content of the cobalt coated was 3% by mass or more and 5% by mass or less.

Oxidation Treatment of Nickel-Containing Hydroxide Coated with Cobalt Hydroxide

The suspension of the nickel-containing hydroxide coated with cobalt hydroxide obtained as described above was subjected to solid-liquid separation to obtain dry powder of the nickel-containing hydroxide coated with cobalt hydroxide. Oxidation treatment was carried out by adding a 48% by mass aqueous sodium hydroxide solution to the obtained dry powder of the nickel-containing hydroxide coated with cobalt hydroxide, mixing the mixture under heating conditions such that the sum of A1 to A15 described above was 412.7 (° C.×min), and further heating and drying the mixture for 1 hour at 120° C. while mixing. Note that 0.10 parts by mass of a 48% by mass aqueous sodium hydroxide solution were added to 1.0 part by mass of the dry powder of the nickel-containing hydroxide coated with cobalt hydroxide. In the above oxidation treatment, the cobalt hydroxide in the coating layer formed on the surface of nickel-containing hydroxide particles was oxidized to give cobalt oxyhydroxide as trivalent cobalt.

### Solid-Liquid Separation and Drying Treatment

Thereafter, the nickel-containing hydroxide coated with the cobalt oxyhydroxide obtained in the oxidation treatment was subjected to each treatment of washing with water, dehydration, and drying to obtain a nickel-containing hydroxide coated with cobalt of Example 1.

### Example 2

A nickel-containing hydroxide coated with cobalt of Example 2 was obtained in the same manner as in Example 1, except that the heating conditions were such that the sum of A1 to A15 described above was 394.7 (° C.×min).

### Comparative Example 1

A nickel-containing hydroxide coated with cobalt of Comparative Example 1 was obtained in the same manner as in Example 1, except that the heating conditions were such that the sum of A1 to A15 described above was 424.2 (° C.×min).

### Comparative Example 2

A nickel-containing hydroxide coated with cobalt of Comparative Example 2 was obtained in the same manner as in Example 1, except that the heating conditions were such that the sum of A1 to A15 described above was 428.0 (° C.×min).

### Evaluation Item

### (1) Average Circularity at a Particle Diameter (D50) or More at a Cumulative Volume Percentage of 50% by Volume

The circularity of each of 10,000 nickel-containing hydroxide particles coated with cobalt was measured by a static automatic image analyzer (“Morphologi 4”, Malvern Panalytical Ltd), and the average value of the measured circularities of the nickel-containing hydroxide coated with cobalt of D50 or more was calculated. Specifically, the nickel-containing hydroxide powder coated with cobalt was introduced into a feed unit of the static automatic image analyzer, blown to a prepared slide, and fixed, and 10,000 of the fixed nickel-containing hydroxide particles coated with cobalt were observed with an optical microscope to obtain an image. The obtained image was analyzed to calculate the average circularity of the nickel-containing hydroxide powder coated with cobalt of D50 or more. D50 was measured with a particle size distribution analyzer (“LA-960”, HORIBA, Ltd.) (the principle was a laser diffraction scattering method).

Measurement conditions for the static automatic image analyzer are as follows.
Magnification: ×50 (0.5 μm to 50 μm)

### (2) D10, D50, and D90

For the nickel-containing hydroxide coated with cobalt, D10, D50, and D90 were measured with a particle size distribution analyzer (“LA-960”, HORIBA, Ltd.) (the principle was a laser diffraction scattering method), as described above. Measurement conditions were such that water was used as the solvent, 1 mL of sodium hexametaphosphate was fed as a dispersing agent, the transmittance after sample feeding was set to a range of 85±3%, and the sample was dispersed by generating ultrasonic waves. As the solvent refractive index in the analysis, 1.333 which is the refractive index of water was used.

### (3) Volume Resistivity

Using an MCP-PD51 powder resistivity system (Loresta) manufactured by Mitsubishi Chemical Analytech Co., Ltd., the volume resistivity (Ω·cm) of the obtained nickel-containing hydroxide powder coated with cobalt was measured under the following conditions.
Probe used: four-point probe
Electrode interval: 3.0 mm
Electrode radius: 0.7 mm
Sample radius: 10.0 mm
Sample mass: 3.00 g
Pressure applied: 20 kPa

### (4) Uneven Coating Preventing Property

Materials were mixed in a ratio of nickel-containing hydroxide coated with cobalt:binder (carboxymethylcellulose (CMC)):water=1:0.1:0.2 (mass ratio) to prepare a positive electrode active material slurry, and a 0.015 mm aluminum foil was coated with the positive electrode active material slurry using an applicator so as to have a thickness of 0.1 mm, thereby producing a positive electrode active material layer on the surface of the aluminum foil. The thickness (unit: mm) of the positive electrode active material layer was randomly measured at 10 points (n=10), and the variation in the thickness was calculated as the standard deviation.

### (5) Tap Density

For the nickel-containing hydroxide coated with cobalt, the tap density was measured by the constant mass measurement method among the methods described in JIS R1628, using a Tap Denser (“KYT-4000” manufactured by SEISHIN ENTERPRISE Co., Ltd.).

### (6) BET Specific Surface Area

After 1 g of the nickel-containing hydroxide coated with cobalt was dried in a nitrogen atmosphere at 105° C. for 30 minutes, the specific surface area was measured by the BET single point method, using a specific surface area measurement apparatus (“Macsorb”, Mountech Co., Ltd.).

### (7) Composition of Nickel-Containing Hydroxide

Using 5 g of the nickel-containing hydroxide, the composition was measured with a wavelength dispersive X-ray fluorescence spectrometer (“ZSX Primus”, Rigaku Corporation).

The results of the average circularity of the nickel-containing hydroxide coated with cobalt of D50 or more, D50 of the nickel-containing hydroxide coated with cobalt, the volume resistivity of the nickel-containing hydroxide coated with cobalt, the standard deviation of the variation in the thickness of the positive electrode active material layer, the tap density of the nickel-containing hydroxide coated with cobalt, and the BET specific surface area of the nickel-containing hydroxide coated with cobalt are shown in Table 1, and the data for N=10 with respect to the standard deviation of the variation in the thickness of the positive electrode active material layer are shown in Table 2.

TABLE 1

| | | | | Standard deviation | | | |
|---|---|---|---|---|---|---|---|
| | | | | of variation in | | | Sum of A1 |
| | | | | thickness of | | BET | to A15 in |
| | Average | | | positive electrode | | specific | alkaline |
| | circularity | | Volume | active material | Tap | surface | oxidation |
| | at D50 or | D50 | resistivity | layer | density | area | treatment |
| | more | (μm) | (Ω · cm) | (mm) | (g/cm³) | (m²/g) | (° C. · min) |
| Example 1 | 0.915 | 11.4 | 2.3 | 0.004 | 2.17 | 14.7 | 412.7 |
| Example 2 | 0.935 | 11.8 | 2.9 | 0.003 | 2.17 | 15.0 | 394.7 |
| Comparative | 0.892 | 11.1 | 3.4 | 0.011 | 2.21 | 12.6 | 424.2 |
| Example 1 | | | | | | | |
| Comparative | 0.861 | 12.2 | 5.9 | 0.014 | 2.21 | 14.4 | 428.0 |
| Example 2 | | | | | | | |

TABLE 2

| | Example | Example | Comparative | Comparative |
|---|---|---|---|---|
| | 1 | 2 | Example 1 | Example 2 |
| N = 1 | 0.085 | 0.091 | 0.085 | 0.086 |
| N = 2 | 0.083 | 0.094 | 0.092 | 0.088 |
| N = 3 | 0.091 | 0.095 | 0.094 | 0.088 |
| N = 4 | 0.092 | 0.095 | 0.096 | 0.090 |
| N = 5 | 0.092 | 0.101 | 0.098 | 0.090 |
| N = 6 | 0.093 | 0.097 | 0.100 | 0.092 |
| N = 7 | 0.093 | 0.097 | 0.108 | 0.108 |
| N = 8 | 0.094 | 0.098 | 0.109 | 0.116 |
| N = 9 | 0.094 | 0.100 | 0.114 | 0.120 |
| N = 10 | 0.096 | 0.100 | 0.122 | 0.121 |
| Standard deviation | 0.004 | 0.003 | 0.011 | 0.014 |
| Average | 0.091 | 0.097 | 0.102 | 0.100 |

As shown in Tables 1 and 2, the standard deviation of the variation in the thickness of the positive electrode active material layer was respectively reduced to 0.004 mm and 0.003 mm in Examples 1 and 2 in which the average circularity of the nickel-containing hydroxide coated with cobalt of D50 or more was 0.900 or more and 0.990 or less, so that uneven coating of the nickel-containing hydroxide coated with cobalt during production of the positive electrode was successfully reduced and an increase in battery resistance was successfully prevented. In addition, it was found that the volume resistivity was respectively reduced to 2.3 Ω·cm and 2.9 Ω·cm in Examples 1 and 2.

As shown in Table 1, the tap density was 2.17 g/cm³, and the BET specific surface area was respectively 14.7 m²/g and 15.0 m²/g in Examples 1 and 2. As described above, the sum of A1 to A15 in the alkaline oxidation treatment described above was controlled in a range of 350 or more and 420 or less in Examples 1 and 2.

Meanwhile, as shown in Table 1, the standard deviation of the variation in the thickness of the positive electrode active material layer was respectively 0.011 mm and 0.014 mm in Comparative Example 1 in which the average circularity of the nickel-containing hydroxide coated with cobalt of D50 or more was 0.892 and in Comparative Example 2 in which the average circularity was 0.861, so that uneven coating of the nickel-containing hydroxide coated with cobalt during production of the positive electrode could not be reduced and an increase in battery resistance could not be sufficiently prevented. In addition, the volume resistivity was 5.9 Ω·cm in Comparative Example 2, it was found that reduced volume resistivity could not be obtained.

As shown in Table 1, the sum of A1 to A15 in the alkaline oxidation treatment described above was respectively 424.2 and 428.0 in Comparative Examples 1 and 2, and was not controlled in a range of 350 or more and 420 or less.

Since the nickel-containing hydroxide coated with cobalt of an embodiment of the present disclosure having an average circularity at D50 or more in a range of 0.900 or more and 0.990 or less can reduce uneven coating of the nickel-containing hydroxide coated with cobalt during production of the positive electrode and prevent an increase in battery resistance, and has reduced volume resistivity of the nickel-containing hydroxide coated with cobalt, the nickel-containing hydroxide coated with cobalt of an embodiment of the present disclosure is widely available in the field of secondary batteries, and is for example, highly valuable in the field of nickel hydrogen secondary batteries in which high battery characteristics such as a higher output and an improvement in the utilization factor are required.

What is claimed is:

1. A nickel-containing hydroxide coated with cobalt, having a coating layer containing cobalt oxyhydroxide formed on a nickel-containing hydroxide, wherein
an average circularity of particles having particle diameters equal to or more than a particle diameter at a cumulative volume percentage of 50% (D50) within a range of 0.900 or more and 0.990 or less.

2. The nickel-containing hydroxide coated with cobalt according to claim 1, wherein the particle diameter at a cumulative volume percentage of 50% (D50) is 8.5 μm or more and 14.5 μm or less.

3. The nickel-containing hydroxide coated with cobalt according to claim 1, wherein a volume resistivity is 4.0 Ω·cm or less.

4. The nickel-containing hydroxide coated with cobalt according to claim 1, wherein the nickel-containing hydroxide comprises nickel (Ni) and one or more additive metal elements M selected from the group consisting of cobalt (Co) and zinc (Zn).

5. The nickel-containing hydroxide coated with cobalt according to claim 4, wherein a molar ratio of nickel (Ni):additive metal element M is 100-m:m (provided that 0.00≤m≤20.0).

6. The nickel-containing hydroxide coated with cobalt according to claim 1, wherein the nickel-containing hydroxide coated with cobalt comprises nickel (Ni) and cobalt (Co), or nickel (Ni), cobalt (Co), and zinc (Zn), and a molar ratio of nickel (Ni):cobalt (Co):zinc (Zn) is 100-x-y:x:y (provided that 0.00<x≤10.0 and 0.00≤y≤10.0).

7. The nickel-containing hydroxide coated with cobalt according to claim 1, wherein a BET specific surface area is 10.0 m²/g or more and 25.0 m²/g or less.

8. The nickel-containing hydroxide coated with cobalt according to claim 1, wherein a tap density is 1.5 g/cm³ or more and 2.4 g/cm³ or less.

9. The nickel-containing hydroxide coated with cobalt according to claim 1, wherein the nickel-containing hydroxide coated with cobalt is for a positive electrode active material of a nickel hydrogen secondary battery.

10. A positive electrode having the nickel-containing hydroxide coated with cobalt according to claim 1 and a metal current collector.

11. A nickel hydrogen secondary battery comprising the positive electrode according to claim 10.

12. A method for producing a nickel-containing hydroxide coated with cobalt, comprising:
a step of preparing a nickel-containing hydroxide, the step including adding a metal salt solution containing nickel, an alkaline solution, and a complexing agent into a reaction vessel to prepare a nickel-containing hydroxide by a crystallization reaction,
a step of preparing a nickel-containing hydroxide on which a coating layer containing cobalt is formed, the step including adding the nickel-containing hydroxide, a cobalt salt solution, an alkaline solution, and a complexing agent into a reaction vessel to form a coating layer containing divalent cobalt on the surface of nickel-containing hydroxide particles by a crystallization reaction, and
an oxidation step of adding an alkaline solution to the nickel-containing hydroxide on which the coating layer containing cobalt is formed under heating conditions to chemically oxidize the divalent cobalt in the coating layer, wherein
a temperature (° C.) of an alkaline solution-containing material obtained by adding the alkaline solution to the nickel-containing hydroxide on which a coating layer containing cobalt is formed at 0 seconds from the start of addition of the alkaline solution, and temperatures (° C.) of the alkaline solution-containing material until 280 seconds after the start of addition of the alkaline solution are measured every 20 seconds from the start of addition of the alkaline solution, and a sum of calculated values A (° C.×min) every 20 seconds represented by [the temperature of the alkaline solution-containing material (° C.)×20 (seconds)]/60 from 0 seconds until 300 seconds from the start of addition of the alkaline solution is 350 or more and 420 or less.

13. The method for producing a nickel-containing hydroxide coated with cobalt according to claim 12, wherein the oxidation step is carried out in a reaction vessel, and a gas phase in the reaction vessel is replaced with heated gas.

14. The method for producing a nickel-containing hydroxide coated with cobalt according to claim 12, wherein the oxidation step is carried out in a reaction vessel, and the alkaline solution-containing material is dried in the reaction vessel.
